(19) United States
(12) Patent Application Publication
(10) Pub. No.: US 2025/0123978 A1
(43) Pub. Date: Apr. 17, 2025

(54) INFORMATION PROCESSING DEVICE, COMPUTER-READABLE RECORDING MEDIUM STORING PROGRAM, AND CONTROL METHOD

(71) Applicant: Fujitsu Limited, Kawasaki-shi (JP)

(72) Inventors: Hiroyoshi KODAMA, Isehara (JP); Makoto MAKINO, Kawasaki (JP)

(73) Assignee: Fujitsu Limited, Kawasaki-shi (JP)

(21) Appl. No.: 18/808,739

(22) Filed: Aug. 19, 2024

(30) Foreign Application Priority Data
Oct. 13, 2023 (JP) 2023-177487

(51) Int. Cl. G06F 13/20; G06F 13/40

(52) U.S. Cl. CPC G06F 13/20; G06F 13/4022; G06F 2213/40

(57) ABSTRACT

An information processing device includes a memory, and a processor coupled to the memory and configured to, in a case of detecting a processing delay with respect to a processing target in a first device of a plurality of devices included in a first calculation base and where each usage status of the plurality of devices included in the first calculation base satisfies a predefined remote load distribution condition, cause a second device of unused devices of the plurality of devices, the second device being included in a second calculation base, a connection delay of the second calculation base being less than a predetermined value, to process the processing target, based on each usage status of the plurality of devices included in each of the plurality of calculation bases and each connection delay of a communication path from the first calculation base to each of the plurality of calculation bases.

### CROSS-REFERENCE TO RELATED APPLICATION

This application is based upon and claims the benefit of priority of the prior Japanese Patent Application No. 2023-177487, filed on Oct. 13, 2023, the entire contents of which are incorporated herein by reference.

### FIELD

The embodiments discussed herein are related to an information processing device, a computer-readable recording medium storing a program, and a control method.

### BACKGROUND

In recent years, since a central processing unit (CPU) manufacturing process approaches the limit, an increase in a calculation performance of the CPU is reduced as compared to the past. Therefore, efforts for improving the performance at a system level have been actively made.

For example, as one of application performance improvement methods, hardware that is generally called an accelerator such as a graphics processing unit (GPU) or a field programmable gate array (FPGA) has been used in addition to the CPU. Furthermore, a communication function of the CPU is offloaded to a device called a smart network interface card (SmartNIC).

Furthermore, in recent years, the accelerator such as the FPGA or the GPU is coupled to the CPU via an interconnect. As the interconnect of such a system configuration, a compute express link (CXL: registered trademark) has been known. For example, a system for managing a memory resource coupled by a CXL switch has been known.

U.S. Patent Application Publication No. 2020/0242724, U.S. Patent Application Publication No. 2018/0300238, Japanese Laid-open Patent Publication No. 2021-190125, and Japanese National Publication of International Patent Application No. 2023-529831 are disclosed as related art.

### SUMMARY

According to an aspect of the embodiments, an information processing device included in a first calculation base of a plurality of calculation bases, in a computer system that includes the plurality of calculation bases each that includes a first processor, an interconnect switch that conforms to an interconnect standard, and a plurality of devices coupled to the first processor via the interconnect switch, the information processing device includes a memory, and a second processor coupled to the memory and configured to, in a case of detecting a processing delay with respect to a processing target in a first device of the plurality of devices included in the first calculation base and where each usage status of the plurality of devices included in the first calculation base satisfies a predefined remote load distribution condition, cause a second device of unused devices of the plurality of devices, the second device being included in a second calculation base of the plurality of calculation bases, a connection delay of the second calculation base being less than a predetermined value, to process the processing target, based on each usage status of the plurality of devices included in each of the plurality of calculation bases and each connection delay of a communication path from the first calculation base to each of the plurality of calculation bases.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a computer system according to a first embodiment;

FIG. 2 is a diagram illustrating a hardware configuration of a control unit (CU) in the computer system according to the first embodiment;

FIG. 3 is a diagram illustrating functional configurations of a CXL extension functional unit, a CU, and an FPGA extension functional unit of a master calculation base unit of the computer system according to the first embodiment;

FIG. 4 is a diagram illustrating functional configurations of a CXL extension functional unit, a CU, and an FPGA extension functional unit of a slave calculation base unit of the computer system according to the first embodiment;

FIG. 5 is a diagram illustrating a parallel processing enhancement method in the computer system as an example of the first embodiment;

FIG. 6 is a diagram illustrating calculation base management information of the computer system according to the first embodiment;

FIG. 7 is a diagram for explaining processing of a CU cooperative processing unit of the computer system according to the first embodiment;

FIG. 8 is a sequence diagram for explaining processing in a local load distribution mode of the computer system as an example of the first embodiment;

FIG. 9 is a diagram illustrating states of the computer system before and after the processing illustrated in the sequence diagram in FIG. 8;

FIG. 10 is a sequence diagram for explaining processing in a remote load distribution mode of the computer system as an example of the first embodiment;

FIG. 11 is a diagram illustrating calculation base management information of a computer system according to a second embodiment; and

FIG. 12 is a sequence diagram for explaining processing in a remote load distribution mode of the computer system as an example of the second embodiment.

### DESCRIPTION OF EMBODIMENTS

Since an interface using such a typical CXL switch only manages a memory, it is not possible to manage an FPGA and a GPU. Therefore, there is a problem that, in a case where data processing beyond expectation is requested to the FPGA and the GPU from an application, a delay of processing occurs.

Hereinafter, embodiments of techniques capable of reducing a processing delay will be described with reference to the drawings. Note that the embodiments described below are merely examples, and there is no intention to exclude application of various modifications and techniques not explicitly described in the embodiments. For example, the individual embodiments may be modified in various manners (such as combining individual embodiments and individual modifications) and implemented in a range without departing from the scope of the present embodiments. Furthermore, each drawing is not intended to include only the components illustrated in the drawing, and may include other functions and the like.

### First Embodiment

### [A] Configuration

### [A-1] Hardware Configuration Example

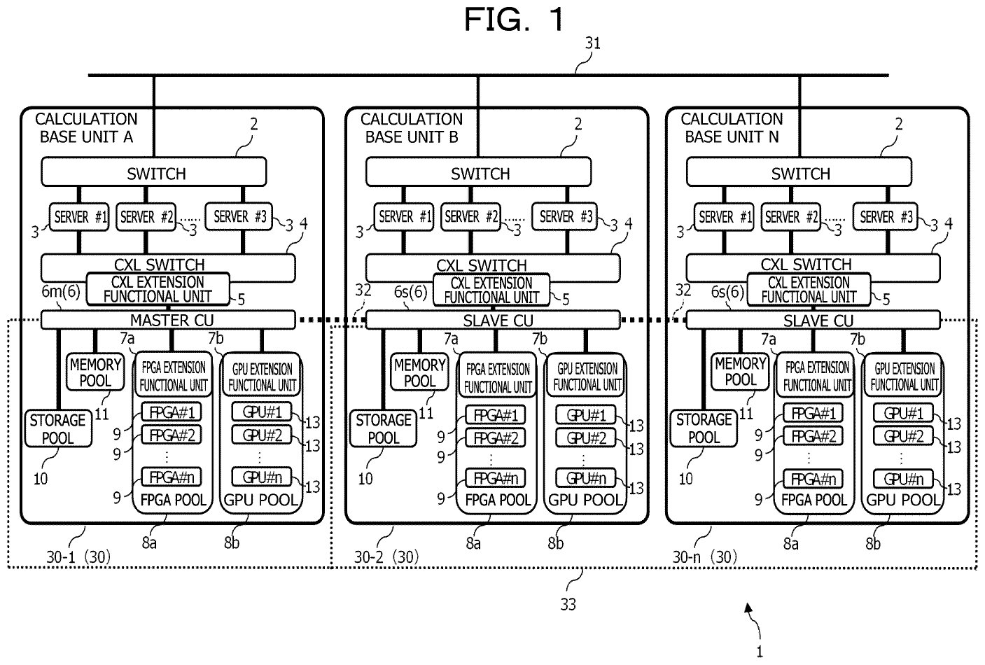

FIG. 1 is a diagram illustrating a configuration of a computer system 1 according to a first embodiment.

The computer system 1 illustrated in FIG. 1 includes a plurality of (n in the example illustrated in FIG. 1) calculation base units 30-1 to 30-n. The reference n is a natural number. The calculation base unit 30-1 may be referred to as a calculation base unit A. Similarly, the calculation base unit 30-2, the calculation base unit 30-3, and the calculation base unit 30-n may be referred to as a calculation base unit B, a calculation base unit C, and a calculation base unit N, respectively.

Furthermore, hereinafter, in a case where the calculation base units 30-1 to 30-n are not particularly distinguished from each other, the calculation base units 30-1 to 30-n are referred to as a calculation base unit 30.

The calculation base unit 30 is a calculation base that performs calculation using a plurality of types of devices (calculation resources). The calculation base units 30 are communicably coupled to each other via a network 31. The network 31 may conform to, for example, the Ethernet (registered trademark) standard, and may be, for example, a local area network (LAN). Furthermore, a user terminal (not illustrated) is coupled to the network 31.

The user terminal is a computer that a user uses. The number of user terminals may be plural.

As illustrated in FIG. 1, each calculation base unit 30 includes a switch 2, a CXL switch 4, a CXL extension functional unit 5, a control unit (CU) 6, a storage pool 10, an FPGA extension functional unit 7a, a GPU extension functional unit 7b, a FPGA pool 8a, a GPU pool 8b, a memory pool 11, and one or more (m in the example illustrated in FIG. 1) servers 3. The reference m is a natural number.

The switch 2 couples the calculation base unit 30 on which the switch 2 is mounted to the network 31, and controls various communications via the network 31. Furthermore, the plurality of servers 3 are coupled to the switch 2.

For example, the switch 2 controls communication between the user terminal and the plurality of servers 3. For example, the switch 2 transfers a job transmitted from the user terminal to the corresponding server 3. Furthermore, the switch 2 transfers a job execution result responded from the server 3 to the user terminal. The switch 2 may be, for example, a top of rack (ToR) switch or a SmartNIC.

The user terminal inputs a job based on an operation of the user or the like. The job input from the user terminal is transmitted to any one of the plurality of servers 3, via the switch 2.

A plurality of storage devices (device) are registered in the storage pool 10. In response to a request from the server 3, a storage area of the storage device of the storage pool 10 is provided. A plurality of memory devices (device) are registered in the memory pool 11. In response to a request from the server 3, a memory area of the memory device of the memory pool 11 is provided.

An FPGA (device) 9 is registered in the FPGA pool 8a. The job input from the user terminal is transmitted to the FPGA 9 of the FPGA pool 8a via the server 3, the CXL switch 4, and the CU 6. The FPGA 9 processes the received job and responds an execution result (transmits a result) to the server 3 via the CU 6 and the CXL switch 4. The server 3 transmits the responded execution result to the user terminal.

In the plurality of FPGAs 9 registered in the FPGA pool 8a, an FPGA 9 in a hot standby (hot spare) state where a job is not processed may be included. The FPGA 9 in the hot standby (hot spare) state where a job is not processed (task is not executed) in the FPGA pool 8a may be referred to as an empty FPGA 9. Furthermore, the number of empty FPGAs 9 in the FPGA pool 8a may be referred to as the number of empty FPGAS.

The FPGA extension functional unit 7a is included in the FPGA pool 8a. The FPGA extension functional unit 7a is intervened between the CU 6 and the FPGA pool 8a. The FPGA extension functional unit 7a manages the FPGA 9 of the FPGA pool 8a, according to a special packet transmitted from the CU 6 (CXL switch 4). Details of the FPGA extension functional unit 7a will be described later.

A plurality of GPUs (device) 13 are registered in the GPU pool 8b. A program input from the user terminal is transmitted to the GPU 13 of the GPU pool 8b via the server 3, the CXL switch 4, and the CU 6. The GPU 13 executes the received program and responds an execution result (transmits a result) to the server 3 via the CU 6 and the CXL switch 4. The server 3 transmits the responded execution result to the user terminal.

In the plurality of GPUs 13 registered in the GPU pool 8b, a GPU 13 in a hot standby (hot spare) state where a program is not executed may be included.

The GPU extension functional unit 7b is included in the GPU pool 8b. The GPU extension functional unit 7b is intervened between the CU 6 and the GPU pool 8b. The GPU extension functional unit 7b manages the GPU 13 of the GPU pool 8b, according to the special packet transmitted from the CU 6 (CXL switch 4).

The server 3 is a computer having a server function. Each server 3 includes a processor (not illustrated) and implements various functions as the processor executes the program. The processor of the server 3 may be a CPU. The processor of the server 3 is an example of a first processor.

When processing the job transmitted from the user terminal, the server 3 transmits a job processing request (inputs a job), to the FPGA 9 of the FPGA pool 8a, as necessary.

Here, the job that the server 3 issues may include a plurality of tasks. Furthermore, these tasks may be processed by the plurality of FPGAs 9. Moreover, the plurality of tasks may be classified into a plurality of flows, and the plurality of flows may be processed in parallel by the plurality of FPGAs 9.

Furthermore, the server 3 requests the storage area and the memory area to the storage pool 10 and the memory pool 11.

The CXL switch 4 is an interconnect switch conforming to an interconnect standard. The CXL switch 4 is coupled to the plurality of servers 3 and is coupled to the storage pool 10, the memory pool 11, the FPGA pool 8a, and the GPU pool 8b via the CU 6. The CXL switch 4 controls communication between the plurality of servers 3, the storage device included in the storage pool 10, the memory included in the memory pool 11, the FPGA 9 included in the FPGA pool 8a, and the GPU 13 included in the GPU pool 8b. The CXL switch 4 generates and processes packets according to each protocol of CXL.io, CXL.cache, and CXL.mem.

The CXL extension functional unit 5 is added to the CXL switch 4. The CXL extension functional unit 5 extends a function of the CXL switch 4. Details of the CXL extension functional unit 5 will be described later.

The calculation base unit 30 is an example of a calculation base including the processor of the server 3, the CXL switch 4 (interconnect switch), and the plurality of FPGAs 9 (device) coupled to the processor of the server 3 via the CXL switch 4.

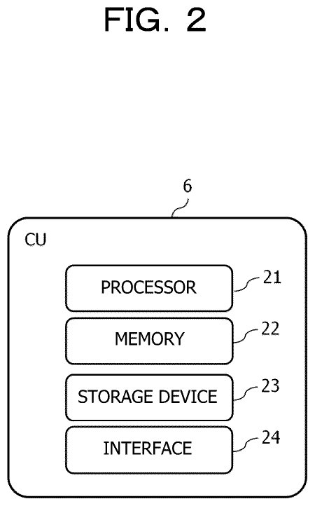

FIG. 2 is a diagram illustrating a hardware configuration of the CU 6 in the computer system 1 according to the first embodiment.

As illustrated in FIG. 2, the CU 6 may be an information processing device that includes a processor 21, a memory 22, a storage device 23, and an interface 24. The calculation base unit 30 is an example of a computer system that includes the processor (first processor) of the server 3, the CXL switch 4 (interconnect switch) conforming to the interconnect standard, and the plurality of devices coupled to the processor of the server 3 via the CXL switch 4. Furthermore, the CU 6 is an example of an information processing device included in this computer system 1.

The processor 21 is an example of an arithmetic processing device that performs various controls and calculations and is a control unit that executes various types of processing. The processor 21 may be communicably coupled to each block in the CU 6 via a bus (not illustrated). Note that the processor 21 may be a multiprocessor including a plurality of processors, or a multi-core processor including a plurality of processor cores, or may have a configuration including a plurality of multi-core processors.

As the processor 21, for example, an integrated circuit (IC) such as a CPU, a micro processing unit (MPU), an accelerated processing unit (APU), a digital signal processor (DSP), an application specific IC (ASIC), or an FPGA is exemplified. Note that a combination of two or more of these integrated circuits may be used as the processor 21. The MPU is an abbreviation for a micro processing unit, and the APU is an abbreviation for an accelerated processing unit. The DSP is an abbreviation for a digital signal processor, and the ASIC is an abbreviation for an application specific IC. The processor 21 is an example of a second processor.

The memory 22 is an example of hardware (HW) that stores information such as various types of data or programs. As the memory 22, for example, one or both of a volatile memory such as a dynamic random access memory (DRAM) and a nonvolatile memory such as a persistent memory (PM) are exemplified.

The storage device 23 is an example of the HW that stores information such as various types of data and programs. As the storage device 23, various storage devices such as a magnetic disk device such as a hard disk drive (HDD), a semiconductor drive device such as a solid state drive (SSD), and a nonvolatile memory are exemplified. As the nonvolatile memory, for example, a flash memory, a storage class memory (SCM), a read only memory (ROM), and the like are exemplified.

The storage device 23 may store a program (communication control program: not illustrated) that implements all or some of various functions of the CU 6.

For example, the processor 21 of the CU 6 can implement various control functions to be described later, by developing and executing the program stored in the storage device 23 on the memory 22.

The program may be read from a recoding medium (not illustrated) that stores the program and be stored in the storage device 23.

As the recording medium, for example, a non-transitory computer-readable recoding medium such as a magnetic/optical disk or a flash memory is exemplified. As the magnetic/optical disk, for example, a flexible disk, a compact disc (CD), a digital versatile disc (DVD), a Blu-ray disc, a holographic versatile disc (HVD), and the like are exemplified. As the flash memory, for example, a semiconductor memory such as a universal serial bus (USB) memory or a secure digital (SD) card is exemplified.

The interface 24 is an interface that is configured to couple the CXL switch 4, the storage pool 10, the memory pool 11, and the FPGA pool 8a, to the CU 6. For example, the interface 24 may include an interface based on a peripheral component interconnect-express (PCIe) standard or may include a PCIe connector.

Furthermore, the interface 24 includes, for example, a low-latency communication function using an optical communication technology. As an example of the low-latency communication function, a co-packaged optics (CPO) may be used. By coupling between the CUS 6 of the plurality of calculation base units 30 via an inter-CU optical coupling line 32, a CU 6 (master CU 6m) of the calculation base unit 30-1 and a slave CU 6s of the farthest calculation base unit 30-n are coupled with a latency equal to or less than 100 ns. This realizes high-speed coupling than a latency to a remote memory of a 2-CPU server.

In the example illustrated in FIG. 1, the CU 6 included in each calculation base unit 30 is cascade-connected by the inter-CU optical coupling line 32, and for example, the CU 6 of the calculation base unit 30-2 is coupled to the CU 6 of the calculation base unit 30-1. The inter-CU optical coupling line 32 is an example of a communication path between a master calculation base unit 30m (first calculation base) and each of a plurality of slave calculation base units 30s (calculation base).

Moreover, the interface 24 includes a communication function for communicating with the CUS 6 of another plurality of calculation base units 30. As an example of the communication function, an Ethernet-compliant network interface may be used, and the CU 6 is coupled to each of the CUS 6 of the another plurality of calculation base units 30 via an inter-CU management coupling line 33, with this network interface. The inter-CU management coupling line 33 may be, for example, a LAN.

The HW configuration of the CU 6 described above is an example. Therefore, an increase/decrease in the HW in the CU 6 (for example, addition or deletion of an optional block), division, integration with an optional combination, addition or deletion of a bus, or the like may be appropriately performed.

Furthermore, in the computer system 1, at least one calculation base unit 30 of the plurality of calculation base units 30 functions as a master, and the calculation base units 30 other than the master function as slaves.

Hereinafter, there is a case where the calculation base unit 30 that functions as the master is referred to as the master calculation base unit 30m, and there is a case where the calculation base unit 30 that functions as the slave is referred to as the slave calculation base unit 30s. Furthermore, in a case where the master calculation base unit 30m and the slave calculation base unit 30s are not particularly distinguished from each other, the master calculation base unit 30m and the slave calculation base unit 30s are referred to as a calculation base unit 30. The master calculation base unit 30m is an example of the first calculation base of the plurality of calculation base units 30.

In the example illustrated in FIG. 1, the calculation base unit 30-1 is the master calculation base unit 30m. Furthermore, each of the calculation base units 30-2 to 30-n is the slave calculation base unit 30s. In a case where the slave calculation base units 30-2 to 30-n are not particularly distinguished from each other, the slave calculation base units 30-2 to 30-n are referred to as the slave calculation base unit 30s.

Furthermore, hereinafter, the CU 6 mounted on the master calculation base unit 30m may be referred to as a master CU 6m. Furthermore, the CU 6 mounted on the slave calculation base unit 30s may be referred to as a slave CU 6s. Then, in a case where the master CU 6m and the slave CU 6s are not particularly distinguished from each other, the master CU 6m and the slave CU 6s are referred to as the CU 6.

The master CU 6m is an example of the information processing device included in the first calculation base (master calculation base unit 30m).

### [A-2] Functional Configuration Example

Hereinafter, a function for controlling the FPGA 9, among the plurality of devices included in the calculation base unit 30 is exemplified.

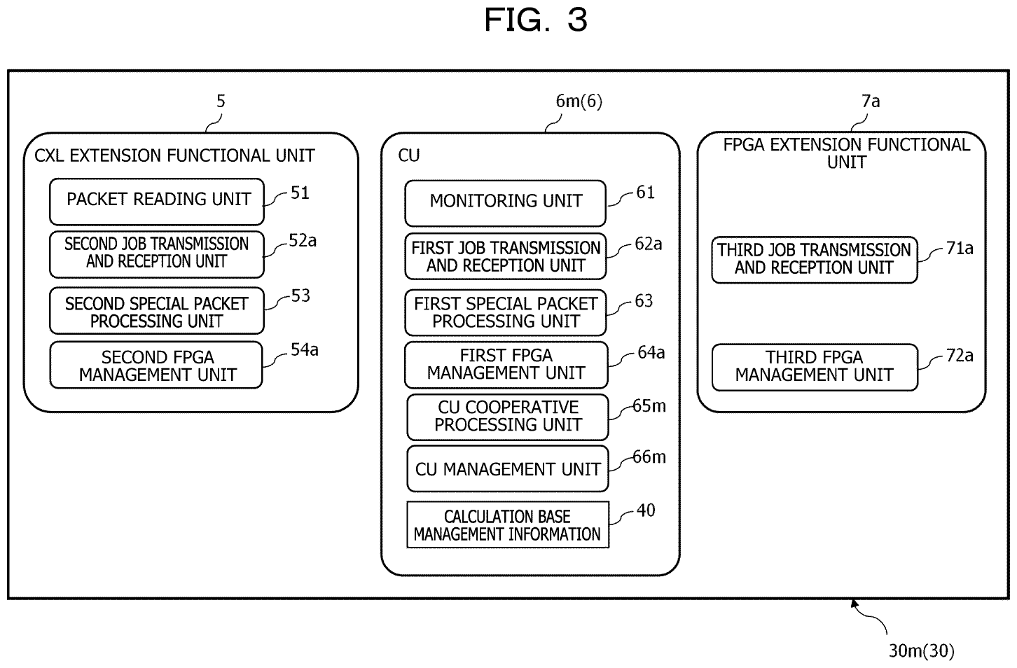

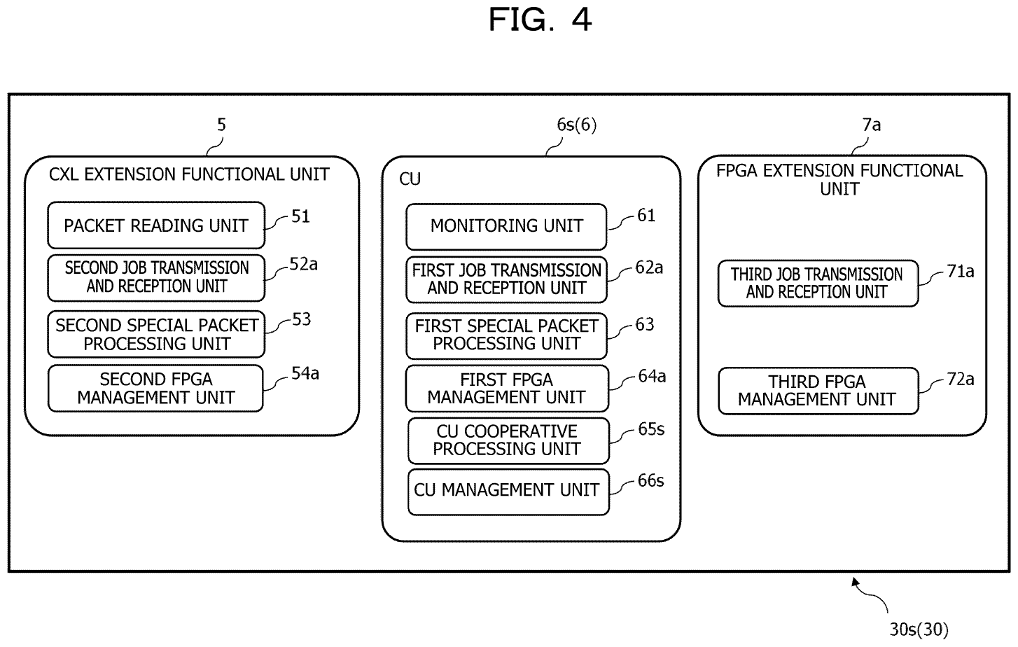

FIG. 3 is a diagram illustrating functional configurations of the CXL extension functional unit 5, the CU 6, and the FPGA extension functional unit 7a of the master calculation base unit 30m of the computer system 1 according to the first embodiment. Furthermore, FIG. 4 is a diagram illustrating functional configurations of the CXL extension functional unit 5, the CU 6, and the FPGA extension functional unit 7a of the slave calculation base unit 30s.

The CU 6 is a control device that controls the plurality of devices (plurality of FPGAs 9 in the present embodiment) included in the master calculation base unit 30, and implements a function for autonomously controlling the FPGA 9 of the FPGA pool 8a, without communicating with the processor of the server 3.

Furthermore, for example, the master CU 6m also controls the plurality of devices (FPGA 9 in the present embodiment) included in each slave calculation base unit 30.

In a case of detecting a processing delay for a processing delay task (processing target) of a processing delay FPGA 9 (first device) of the plurality of FPGAs 9 (devices) included in the calculation base unit 30 (own calculation base unit 30) on which the CU 6 is mounted, the CU (control unit) 6 causes an auxiliary FPGA 9 (second device), different from the processing delay FPGA 9, of the plurality of FPGAs 9 to process the processing delay task to be processed.

Furthermore, in a case where there is no empty FPGA 9 (empty device) in the FPGA pool 8a of the calculation base unit 30 (master calculation base unit 30) on which the master CU 6m is mounted (in a case where the number of empty FPGAs is zero), the master CU 6m causes a remote auxiliary FPGA 9 (second device) of the slave calculation base unit 30 to process the processing delay task to be processed.

In a case where the CU 6 monitors a load state of the FPGA 9 and detects the processing delay in the FPGA 9, the CU 6 realizes balancing of processing loads, by adding the FPGA 9 and auxiliary executing the processing. As illustrated in FIG. 3, the master CU 6m has functions of a monitoring unit 61, a first job transmission and reception unit 62a, a first special packet processing unit 63, a first FPGA management unit 64a, a CU cooperative processing unit 65m, a CU management unit 66m.

The monitoring unit 61 monitors and analyzes an operating state of each FPGA 9 of the FPGA pool 8a of the own calculation base unit 30. The monitoring unit 61 may collect information indicating the operating state of the FPGA 9 from each FPGA 9, as monitoring of the operating state of each FPGA 9.

For example, the monitoring unit 61 may acquire an execution state of the job in each FPGA 9, as the information indicating the operating state of each FPGA 9. The execution state of the job may include, for example, the number of jobs (count) that the FPGA 9 processes, power consumption, an execution time, or the like. The execution time of the job of the FPGA 9 may be a time from when a job is input to the FPGA 9 to a time when a response is output. It can be said that the operating state of the FPGA 9 is a load state of the FPGA 9.

The information indicating the operating state of each FPGA 9 is collected via the FPGA extension functional unit 7a to be described later.

Furthermore, the monitoring unit 61 measures a change in the information indicating the operating state, as analysis on the operating state of each FPGA 9.

For example, the monitoring unit 61 compares the execution time of the job of the FPGA 9 with an execution time of the same job at a previous time by the same FPGA 9. As a result of this comparison, in a case where the execution time of the job is longer than the execution time of the same job at the previous time by a predetermined time (threshold) or longer, the processing delay in the FPGA 9 is detected. The FPGA 9 in which the processing delay is detected may be referred to as the processing delay FPGA 9. Furthermore, a task that the processing delay FPGA 9 is executing may be referred to as the processing delay task.

When the monitoring unit 61 detects the processing delay in the FPGA 9, an operation mode of the computer system 1 shifts from a normal mode to a local load distribution mode.

Furthermore, the monitoring unit 61 monitors the number of empty FPGAs in the own calculation base unit 30 (master calculation base unit 30m). The number of empty FPGAs is the number of empty FPGAs in the calculation base unit 30, and is an example of a usage status of each FPGA 9 (device) coupled to each of the plurality of calculation base units 30 (calculation base).

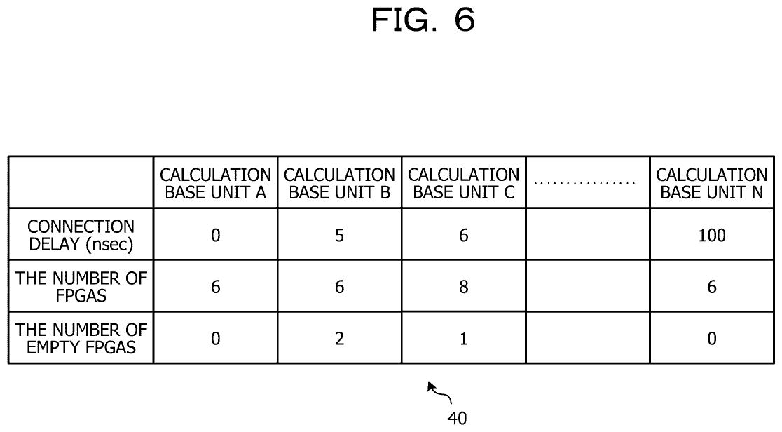

For example, the monitoring unit 61 may manage the number of empty FPGAs in the own calculation base unit 30 (master calculation base unit 30m) using calculation base management information 40 to be described later with reference to FIG. 6.

Furthermore, in a case where the monitoring unit 61 detects the processing delay FPGA 9 (processing delay task) in the master calculation base unit 30m and the usage statuses of the plurality of FPGAs 9 (device) coupled to the master calculation base unit 30m satisfy a predefined remote load distribution condition, the computer system 1 shifts to a remote load distribution mode.

The remote load distribution condition may be, for example, that the number of empty FPGAs in the master calculation base unit 30m is less than the threshold. For example, when the monitoring unit 61 detects the processing delay FPGA 9 (processing delay task) in the master calculation base unit 30 and the number of empty FPGAs in the master calculation base unit 30m is zero, the computer system 1 may shift to the remote load distribution mode. In the remote load distribution mode, the CU management units 66m and 66s and the CU cooperative processing units 65m and 65s to be described later mainly execute processing.

For example, the monitoring unit 61 may store information indicating the operation mode of the computer system 1, in a specific storage area such as the memory 22 of the CU 6. The information indicating the operation mode may be, for example, a flag. In the normal mode, 00 may be set, in the local load distribution mode, 01 may be set, and in the remote load distribution mode, 11 may be set.

Furthermore, in a case of comparing the execution time of the job by the processing delay FPGA 9 with an execution time of the same job in a state where the processing delay does not occur and where a difference between the job execution times is less than a predetermined time (threshold), the monitoring unit 61 detects cancellation of the processing delay in the FPGA 9.

When detecting the cancellation of the processing delay in the FPGA 9, the monitoring unit 61 shifts the operation mode of the computer system 1 from the local load distribution mode or the remote load distribution mode to the normal mode.

Furthermore, in a case of detecting the processing delay in the FPGA 9, the monitoring unit 61 determines an FPGA 9 that assists the processing of the processing delay task of the processing delay FPGA 9, from among the plurality of FPGAs 9 in the FPGA pool 8a, in the local load distribution mode. The FPGA 9 that assists the processing of the processing delay task of the processing delay FPGA 9 may be referred to as the auxiliary FPGA 9. By also causing the auxiliary FPGA 9 to execute the processing (do parallel processing) of the processing delay task of the processing delay FPGA 9, it is possible to realize load distribution.

The processing delay FPGA 9 is an example of the first device of the plurality of devices. Furthermore, the auxiliary FPGA 9 is an example of the second device different from the first device, of the plurality of devices.

The monitoring unit 61 may select the auxiliary FPGA 9, from among the FPGAs 9 in the hot standby state in the FPGA pool 8a, according to characteristics of the processing delay task. For example, the monitoring unit 61 may select the auxiliary FPGA 9, according to any one of the following rules 1 to 3.

### Rule 1

For example, in a case where the processing delay task includes a large number of loop processing, as the characteristics of the processing delay task, the monitoring unit 61 determines to append (add) a small FPGA 9 of which a circuit size is equal to or less than a first threshold, as the auxiliary FPGA 9. As a result, the processing delay FPGA 9 and the auxiliary FPGA 9 are caused to do parallel processing of the processing delay task.

Note that, a case where the processing delay task includes a large number of loop processing may include a predetermined number of loops or more or a large number of loops in the loop processing.

### Rule 2

For example, in a case where the processing delay task includes high-load processing, as the characteristics of the processing delay task, the monitoring unit 61 determines an FPGA 9 having a higher processing performance than the processing delay FPGA 9, as the auxiliary FPGA 9. For example, the monitoring unit 61 determines to use a large-scale FPGA 9 of which the circuit size is larger than the first threshold, as the auxiliary FPGA 9. The monitoring unit 61 offloads the processing of the processing delay task being executed by the processing delay FPGA 9, to the higher-speed auxiliary FPGA 9.

### Rule 3

For example, in a case where the processing delay task includes a large number of the same processing, as the characteristics of the processing delay task, the monitoring unit 61 determines to add the auxiliary FPGA 9 having a circuit size equivalent to that of the processing delay task. As a result, the processing delay FPGA 9 and the auxiliary FPGA 9 are caused to do parallel processing of the processing delay task.

Furthermore, in a case where the monitoring unit 61 detects, for example, the cancellation of the processing delay, in the processing delay FPGA 9, the monitoring unit 61 may shift the operation mode of the computer system 1 from the local load distribution mode or the remote load distribution mode to the normal mode. The monitoring unit 61 updates the information indicating the operation mode of the computer system 1.

The monitoring unit 61 may select the auxiliary FPGA 9 from among the FPGAs 9 in the hot standby state in the FPGA pool 8a. For example, the monitoring unit 61 may randomly determine the auxiliary FPGA 9, from among the plurality of FPGAs 9 in the hot standby state. Furthermore, the monitoring unit 61 may preferentially select the FPGA 9 having the circuit size equivalent to that of the processing delay FPGA 9, from among the FPGAs 9 in the hot standby state, as the auxiliary FPGA 9. Moreover, the monitoring unit 61 may preferentially select the FPGA 9 having the circuit size larger than that of the processing delay FPGA 9, as the auxiliary FPGA 9.

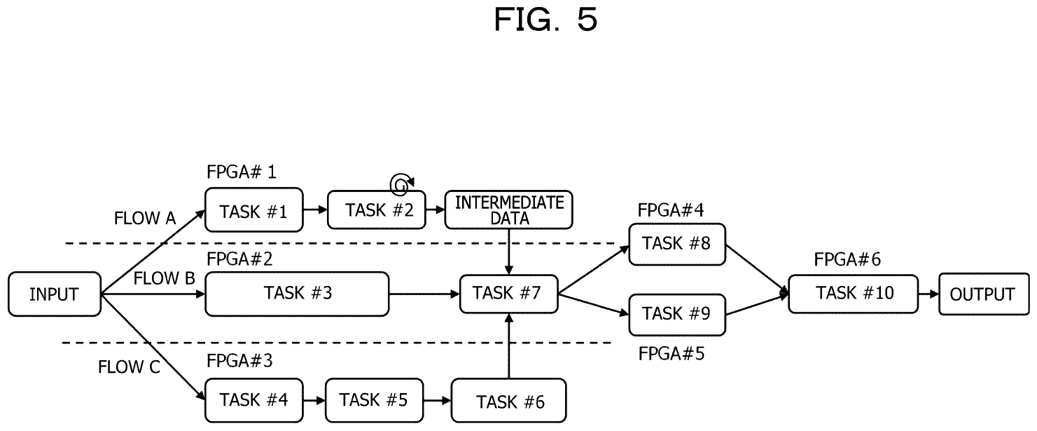

FIG. 5 is a diagram illustrating a parallel processing enhancement method in the computer system 1 as an example of the first embodiment.

In FIG. 5, an example is illustrated in which a job including tasks #1 to #10 is processed. In FIG. 5, the tasks #1 to #7 are divided into three flows A, B, and C, and parallel processed using three FPGAs #1 to #3. Furthermore, an FPGA #4 processes the task #8, an FPGA #5 processes the task #9, and an FPGA #6 processes the task #10, respectively.

For example, in a case where the task #2 includes a large number of loop processing and the monitoring unit 61 detects the processing delay in the FPGA #1, the monitoring unit 61 may append the auxiliary FPGA 9 that processes the task #2 and determine to cause the auxiliary FPGA 9 to perform parallel processing on loops of the task #2, according to the rule 1.

Furthermore, for example, in a case where the task #3 has a high load and the monitoring unit 61 detects the processing delay in the FPGA #2, the monitoring unit 61 may determine to shorten a processing time of the high-load task #3, by offloading the processing of the task #3 to the higher-speed auxiliary FPGA 9, according to the rule 2.

Moreover, for example, in a case where the task #10 includes a large number of the same processing and the monitoring unit 61 detects the processing delay in the FPGA #6, the monitoring unit 61 may determine to append the auxiliary FPGA 9 having the circuit size similar to that of the FPGA #6 and to cause the auxiliary FPGA 9 to execute parallel processing on the processing of the task #10, according to the rule 3.

The first job transmission and reception unit 62a receives a job from the server 3 via the CXL switch 4 (CXL extension functional unit 5). The first job transmission and reception unit 62a implements a function as a slave for receiving the job.

Furthermore, the first job transmission and reception unit 62a transmits a job to the FPGA 9 via the FPGA extension functional unit 7a. The first job transmission and reception unit 62a implements a function as a master for transmitting (sending) the job.

The first FPGA management unit 64a manages information regarding logical arrangement related to each FPGA 9 (configuration information). The configuration information may be stored, for example, in the storage device 23 of the CU 6 in advance. Furthermore, a plurality of types of configuration information may be prepared in advance for each FPGA 9, according to applications, specifications, or the like of the FPGA 9.

The first FPGA management unit 64a reads the configuration information corresponding to the auxiliary FPGA 9 from the storage device 23, according to the auxiliary FPGA 9 determined by the monitoring unit 61, and transfers the configuration information to the first special packet processing unit 63.

When the monitoring unit 61 detects the processing delay in the FPGA 9 and shifts to the local load distribution mode, the first special packet processing unit 63 requests the CXL extension functional unit 5 to be described later, to issue a special packet. The first special packet processing unit 63 transmits information used to specify the auxiliary FPGA 9 and information configuring the auxiliary FPGA 9, together with the special packet issuance request to the CXL extension functional unit 5, to the CXL extension functional unit 5.

The special packet is an extended packet conforming to a CXL protocol, and in which specific information used to control the FPGA 9 is included, in a specific region included in a known packet conforming to the CXL protocol. The special packet is an example of a device control packet used to control the FPGA 9 (device) of the FPGA pool 8a. Hereinafter, the packet conforming to the CXL protocol may be referred to as a CXL packet.

The specific region in the CXL packet may be an unused region such as a spare region in the CXL packet.

The specific information used to control the FPGA 9 may be information used to set the FPGA 9 and may include, for example, information (command) used to initialize the FPGA 9 and information indicating a type and arrangement of a logical block set to the FPGA 9. The specific information used to control the FPGA 9 may include the configuration information regarding the auxiliary FPGA 9, acquired from the first FPGA management unit 64a.

Furthermore, the first special packet processing unit 63 implements a function as a slave that receives the special packet transmitted from the CXL extension functional unit 5 (second FPGA management unit 54a).

The first special packet processing unit 63 transfers the received special packet to the FPGA extension functional unit 7a. This special packet includes the specific information used to control the FPGA 9 that causes the FPGA extension functional unit 7a to perform coupling, initialization, and logical arrangement on the auxiliary FPGA 9. For example, the first special packet processing unit 63 instructs the FPGA extension functional unit 7a to cause the auxiliary FPGA 9 to be in an available state, by transferring the special packet to the FPGA extension functional unit 7a. In the calculation base unit 30, to cause the FPGA 9 to be in the available state may be referred to as mounting.

The CU 6 monitors the operating state (load state) of each FPGA 9 by the monitoring unit 61 and causes the auxiliary FPGA 9 to assist the processing of the processing delay task of the processing delay FPGA 9 in which the processing delay is detected, so as to implement a function as a load balancer that distributes the load between the FPGAs 9. Then, the CU 6 realizes such load distribution (balancing) between the FPGAs 9 without using resources of the server 3.

Furthermore, the CU 6 implements the control such as the initialization or the logical arrangement of the FPGA 9, by requesting the CXL extension functional unit 5 to issue the special packet, by the first special packet processing unit 63. The CU 6 also realizes such control of the FPGA 9, without using the resources of the server 3.

The CU management unit 66m measures a latency (connection delay) of communication of the master calculation base unit 30m to the slave CU 6s of each slave calculation base unit 30 via the inter-CU optical coupling line 32. For example, the CU management unit 66m transmits predefined simulation data to each slave CU 6s via the inter-CU optical coupling line 32. Then, the CU management unit 66m measures each time from a time when this simulation data is transmitted to a time when response data, responded to the simulation data, is received from each slave CU 6s via the inter-CU optical coupling line 32. As a result, the CU management unit 66m obtains the latency of the communication with each slave CU 6s via the inter-CU optical coupling line 32.

The latency of the communication between the master CU 6m and each slave CU 6s via the inter-CU optical coupling line 32 is an example of each connection delay of the communication path between the master calculation base unit 30m (first calculation base) to each of the plurality of calculation base units 30 (calculation base).

The CU management unit 66m manages the latency to each slave CU 6s, using the calculation base management information 40. The CU management unit 66m registers the obtained latency to each slave CU 6s, in the calculation base management information 40.

FIG. 6 is a diagram illustrating the calculation base management information 40 of the computer system 1 according to the first embodiment.

The calculation base management information 40 illustrated in FIG. 6 associates the connection delay, the number of FPGAs, and the number of empty FPGAs, with each calculation base unit 30 included in the computer system 1.

The connection delay is a latency that the CU management unit 66m measured. In the configuration illustrated in FIG. 1, the plurality of CUs 6 is cascade-connected. Therefore, as the number of connection stages from the master CU 6m increases, for example, as a distance increases, the latency increases.

In the example illustrated in FIG. 6, for example, a connection delay with the calculation base unit B is five nsec, and a connection delay with the calculation base unit C is six nsec. Furthermore, since the calculation base unit A is the master calculation base unit 30m, a connection delay is zero nsec.

The number of FPGAs is the number of FPGAs 9 registered in the FPGA pool 8a of each calculation base unit 30. The number of empty FPGAS is the number of empty FPGAs in each calculation base unit 30.

The CU management unit 66m may measure the connection delay and perform the registration in the calculation base management information 40, for example, at the time when the computer system 1 is installed, when the calculation base unit 30 is added, or the like.

Furthermore, for example, the CU management unit 66m inquires the slave CU 6s of each slave calculation base unit 30s about the number of FPGAs and the number of empty FPGAs via the inter-CU management coupling line 33. The CU management unit 66m may register the number of FPGAs and the number of empty FPGAs responded to the inquiry from the slave CU 6s (CU management unit 66s), in the calculation base management information 40.

The CU management unit 66m periodically inquires each slave CU 6s about at least the number of empty FPGAS.

The CU cooperative processing unit 65m of the master CU 6m realizes cooperation with the slave CU 6s, so as to cause the slave calculation base unit 30s to execute a part of the task of the master calculation base unit 30m, in the remote load distribution mode.

The CU cooperative processing unit 65m of the master CU 6m performs control to parallel process the processing delay task using the FPGA 9 of the slave calculation base unit 30s, in the remote load distribution mode. For example, in a case where the monitoring unit 61 detects the processing delay FPGA 9 (processing delay task) in the master calculation base unit 30m, and for example, the number of empty FPGAs of the master calculation base unit 30m is zero, the CU cooperative processing unit 65m performs the control to execute the parallel processing on the processing delay task using the FPGA 9 of the slave calculation base unit 30s.

The CU cooperative processing unit 65m may select an FPGA 9 to be caused to do parallel processing of the processing delay task, from among the empty FPGAs 9 in each slave calculation base unit 30s. For example, the CU cooperative processing unit 65m determines the FPGA 9 that is caused to assist the processing of the processing delay task of the processing delay FPGA 9, from among the plurality of FPGAs 9 in the FPGA pools 8a in one or more slave calculation base units 30s. Therefore, for example, the CU management unit 66m described above may manage the information regarding the FPGA 9 of each slave calculation base unit 30s.

The FPGA 9 that is included in another calculation base unit 30 and assists the processing of the processing delay task of the processing delay FPGA 9 may be referred to as a remote auxiliary FPGA 9. By causing the remote auxiliary FPGA 9 to execute the processing (parallel processing) of the processing delay task of the processing delay FPGA 9, the load distribution can be realized.

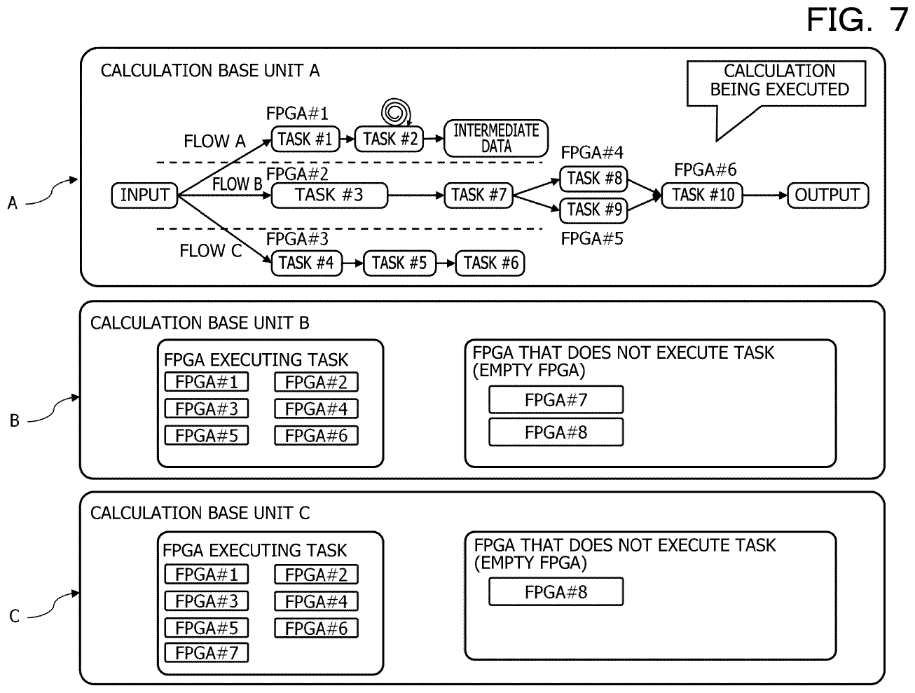

FIG. 7 is a diagram for explaining processing of the CU cooperative processing unit 65m of the computer system 1 according to the first embodiment.

In FIG. 7, a reference A indicates a task being executed by the master calculation base unit 30m (calculation base unit A). Furthermore, a reference B indicates an FPGA 9 that is executing a task and an empty FPGA 9 in the calculation base unit B. Moreover, a reference C indicates an FPGA 9 that is executing a task and an empty FPGA 9 in the calculation base unit C.

In the master calculation base unit 30m (calculation base unit A), 10 tasks #1 to #10 are calculated using six FPGAs 9 (FPGAS #1 to #6).

In the master calculation base unit 30m (calculation base unit A), as indicated by the reference A, the 10 tasks #1 to #10 are calculated using the six FPGAs 9 (FPGAs #1 to #6).

The CU cooperative processing unit 65m (master CU 6m) manages an execution time (processing time) of each task and compares the execution time of each job with an execution time of each job at the previous time, so as to detect occurrence of a processing delay in the task #10, for example.

The CU cooperative processing unit 65m determines the remote auxiliary FPGA 9 from among the FPGAs #7 and #8 in the calculation base unit B and the FPGA #8 in the calculation base unit C, so as to cause the remote auxiliary FPGA 9 to execute the processing delay task #10.

When determining the remote auxiliary FPGA 9, the CU cooperative processing unit 65m may refer to the calculation base management information 40 and exclude a calculation base unit 30 of which a connection delay is equal to or more than a predetermined threshold from candidates.

The CU cooperative processing unit 65m causes the FPGA 9 (second device, remote auxiliary FPGA 9) selected from among the empty FPGAS 9 coupled to the calculation base unit 30 of which the connection delay (latency) is less than the threshold (devices not used), to process a processing target (task or program) for which the processing delay is detected.

The processing delay FPGA 9 is an example of the first device of the plurality of devices. Furthermore, the remote auxiliary FPGA 9 is an example of the second device, different from the first device, of the plurality of devices.

The CU cooperative processing unit 65m selects the remote auxiliary FPGA 9, from among the FPGAs 9 in the hot standby state in the FPGA pool 8a of the slave calculation base unit 30s, according to the characteristics of the processing delay task. The CU cooperative processing unit 65m may select the remote auxiliary FPGA 9, for example, using a method similar to the monitoring unit 61.

Furthermore, the CU cooperative processing unit 65m executes processing to mount the empty FPGA of the slave calculation base unit 30s on the master calculation base unit 30m.

For example, the CU cooperative processing unit 65m instructs the slave CU 6s of the slave calculation base unit 30s including the FPGA 9 determined as the remote auxiliary FPGA 9, to mount the remote auxiliary FPGA 9 and write the task.

For example, the CU cooperative processing unit 65m requests the CXL extension functional unit 5 to issue the special packet. The CU cooperative processing unit 65m transmits information used to specify the remote auxiliary FPGA 9 and information configuring the remote auxiliary FPGA 9, together with the special packet issuance request to the CXL extension functional unit 5, to the CXL extension functional unit 5. The CU cooperative processing unit 65m may execute these processing, using a method similar to the first special packet processing unit 63.

Furthermore, the CU cooperative processing unit 65m implements a function as a slave that receives the special packet transmitted from the CXL extension functional unit 5 (second FPGA management unit 54a).

The CU cooperative processing unit 65m transfers the received special packet to the slave CU 6s of the slave calculation base unit 30s including the remote auxiliary FPGA 9. The slave CU 6s transfers the received special packet to the FPGA extension functional unit 7a of the slave calculation base unit 30s.

This special packet includes specific information used to control the FPGA 9 that causes the FPGA extension functional unit 7a to perform coupling, initialization, and logical arrangement on the remote auxiliary FPGA 9. For example, the CU cooperative processing unit 65m instructs the FPGA extension functional unit 7a to cause the remote auxiliary FPGA 9 to be in an available state, by transferring the special packet to the FPGA extension functional unit 7a of the slave calculation base unit 30s.

As a result, in the slave calculation base unit 30s, the remote auxiliary FPGA 9 is mounted, and the task is written. The slave CU 6s responds to the master CU 6m that the mounting of the remote auxiliary FPGA 9 and the writing of the task are completed.

Furthermore, when the response indicating that the mounting of the remote auxiliary FPGA 9 and the writing of the task are completed is made from the slave calculation base unit 30s, the CU cooperative processing unit 65m mounts the remote auxiliary FPGA 9 on the master calculation base unit 30m. For example, the master CU 6m writes a device number of the remote auxiliary FPGA 9 belonging to (mounted on) the slave calculation base unit 30s into the special packet. The slave CU 6s updates the calculation base management information 40 so as not to count the remote auxiliary FPGA 9 in the number of empty FPGAs. The remote auxiliary FPGA 9 of the slave calculation base unit 30 mounted on the master calculation base unit 30 may be referred to as a remote-mounted FPGA 9.

In this way, by mounting the empty FPGA 9 (remote auxiliary FPGA 9) of the slave calculation base unit 30s on the master calculation base unit 30m, the master calculation base unit 30m can use the remote-mounted FPGA 9 together with the FPGA 9 of the master calculation base unit 30m.

The CU cooperative processing unit 65m causes the CU management unit 66m to update the calculation base management information 40, for the remote-mounted FPGA 9 mounted on the master calculation base unit 30m. In response to this, the CU management unit 66m updates the calculation base management information 40 so as to reduce the number of empty FPGAs of the slave calculation base unit 30s including the remote-mounted FPGA 9.

Furthermore, when batch processing in the master calculation base unit 30m ends, the CU cooperative processing unit 65m instructs the slave CU 6s to unmount the remote-mounted FPGA 9 (unmount instruction).

In a case where a response indicating that the unmounting of the remote-mounted FPGA 9 is completed, is made from the slave CU 6s in response to the unmount instruction, the CU cooperative processing unit 65m causes the CU management unit 66m to update the calculation base management information 40. In response to this, the CU management unit 66m updates the calculation base management information 40 to increase the number of empty FPGAs of the slave calculation base unit 30s including the remote-mounted FPGA 9.

As illustrated in FIG. 4, the slave CU 6s has functions as the monitoring unit 61, the first job transmission and reception unit 62a, the first special packet processing unit 63, the first FPGA management unit 64a, the CU cooperative processing unit 65s, and the CU management unit 66s. Note that, in FIG. 4, since the same reference as the reference described above indicates a similar portion, description thereof is omitted.

Upon receiving a remote mount instruction from the CU cooperative processing unit 65m of the master calculation base unit 30m, the CU cooperative processing unit 65s causes the first FPGA management unit 64a of the slave calculation base unit 30s to read the configuration information corresponding to the auxiliary FPGA 9 (remote auxiliary FPGA 9) from its storage device 23 and instructs to transfer the configuration information to the first special packet processing unit 63.

Furthermore, the CU cooperative processing unit 65s causes the first special packet processing unit 63 to request the CXL extension functional unit 5 to issue a special packet.

Moreover, upon receiving the unmount instruction of the remote-mounted FPGA 9 from the CU cooperative processing unit 65m of the master calculation base unit 30m, the CU cooperative processing unit 65s unmounts the remote-mounted FPGA 9. For example, the CU cooperative processing unit 65m deletes the device number of the FPGA 9 mounted on the own CXL extension functional unit 5. The CU cooperative processing unit 65s registers the FPGA 9 as an empty FPGA in the calculation base management information 40.

The CU management unit 66s responds the number of FPGAs and the number of empty FPGAs via the inter-CU management coupling line 33, to the inquiry about the number of FPGAs and the number of empty FPGAs made from the CU management unit 66s of the master CU 6m via the inter-CU management coupling line 33.

When the CU cooperative processing unit 65s unmounts the remote-mounted FPGA 9 in response to the instruction from the master calculation base unit 30m, the CU management unit 66s updates the number of empty FPGAs that the CU management unit 66s manages.

The CXL extension functional unit 5 generates and issues the special packet, based on the special packet issuance request from the CU 6 (first special packet processing unit 63).

As illustrated in FIGS. 3 and 4, the CXL extension functional unit 5 has functions as a packet reading unit 51, a second job transmission and reception unit 52a, a second special packet processing unit 53, and the second FPGA management unit 54a. For example, the function as the CXL extension functional unit 5 may be implemented by a circuit device, or implemented by executing a program by a processor. The function as the CXL extension functional unit 5 can be performed as appropriately changing the method.

The packet reading unit 51 reads a packet of the CXL protocol transmitted from the server 3.

The second job transmission and reception unit 52a receives the job from the server 3 via the CXL switch 4. The second job transmission and reception unit 52a implements a function as a slave that receives the job.

Furthermore, the second job transmission and reception unit 52a transmits a job to the FPGA 9 via the CU 6. The second job transmission and reception unit 52a also implements a function as a master that transmits (send) the job.

The second FPGA management unit 54a prepares information used to generate the special packet, in response to the special packet issuance request from the CU 6.

The information used to generate the special packet may include, for example, information that instructs to couple the auxiliary FPGA 9, information that instructs to initialize the auxiliary FPGA 9, and information indicating the logical arrangement of the auxiliary FPGA 9.

The information indicating the logical arrangement of the auxiliary FPGA 9 may be, for example, information transmitted from the CU 6 (first special packet processing unit 63) together with the special packet issuance request. Furthermore, the second FPGA management unit 54a may generate or acquire the information indicating the logical arrangement of the auxiliary FPGA 9 by itself.

The second special packet processing unit 53 generates a special packet, in response to the special packet issuance request from the CU 6.

The second special packet processing unit 53 generates the special packet, by storing the information that instructs to couple the auxiliary FPGA 9, the information that instructs to initialize the auxiliary FPGA 9, and the information indicating the logical arrangement of the auxiliary FPGA 9, prepared by the second FPGA management unit 54a, at a predetermined position in the CXL packet.

The second special packet processing unit 53 transmits the generated special packet to the CU 6. The second special packet processing unit 53 implements a function as a master that transmits the special packet.

The CXL extension functional unit 5 is an example of a device control packet generation unit that generates a special packet (device control packet) used to control the auxiliary FPGA 9 (second device), based on a packet conforming to the interconnect standard.

As illustrated in FIG. 3, the FPGA extension functional unit 7a illustratively has a function as a third job transmission and reception unit 71a and a third FPGA management unit 72a. For example, the function as the FPGA extension functional unit 7a may be implemented by a circuit device, or implemented by executing a program by a processor. The function as the FPGA extension functional unit 7a can be performed as appropriately changing the method.

The FPGA extension functional unit 7a is an example of a device control unit and sets the auxiliary FPGA 9 (second device) to be in an operable state, based on the special packet (device control packet) generated by the CXL extension functional unit 5 (device control packet generation unit).

The third job transmission and reception unit 71a transmits the job to the FPGA 9 and receives the job execution result from the FPGA 9. In a case of transmitting the job to the FPGA 9, the third job transmission and reception unit 71a functions as a master, and in a case of receiving the job execution result from the FPGA 9, the third job transmission and reception unit 71a functions as a slave.

The third FPGA management unit 72a performs coupling, initialization, and logical arrangement on the auxiliary FPGA 9, based on the information that instructs to couple the auxiliary FPGA 9, the information that instructs to initialize the auxiliary FPGA 9, and the information indicating the logical arrangement of the auxiliary FPGA 9, included in the special packet.

For example, the third FPGA management unit 72a grasps the auxiliary FPGA 9, based on the information used to specify the auxiliary FPGA 9 included in the special packet. The third FPGA management unit 72a initializes the auxiliary FPGA 9, and in addition, sets the logical arrangement based on the information configuring the auxiliary FPGA 9.

Note that the coupling, the initialization, and the logical arrangement of the FPGA 9 can be implemented by a known method, and description thereof is omitted.

### [B] Operation

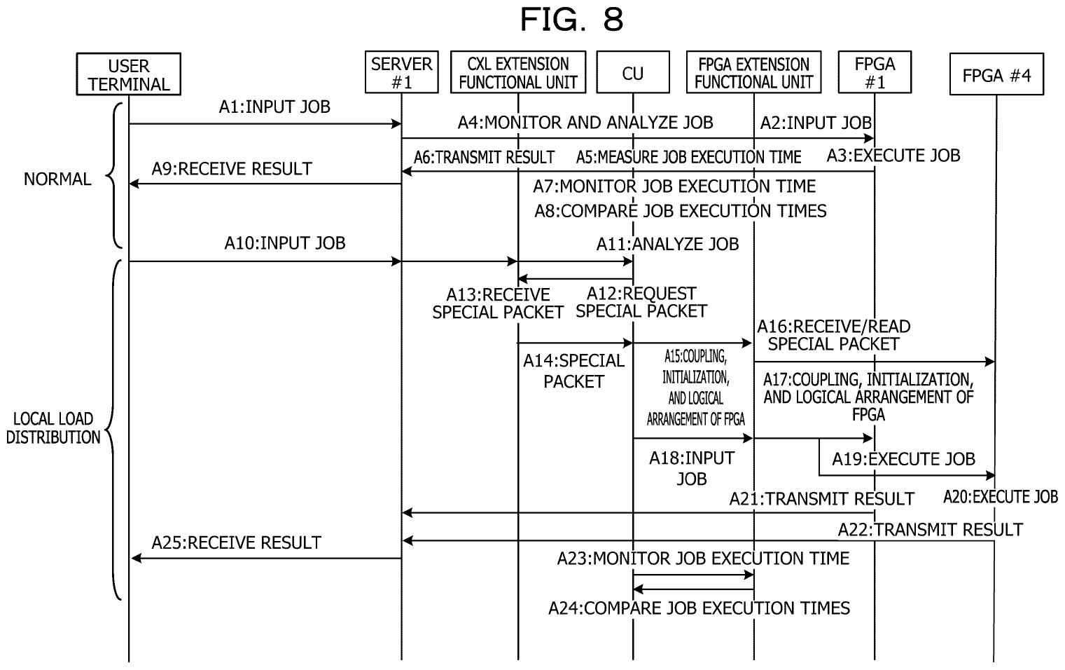

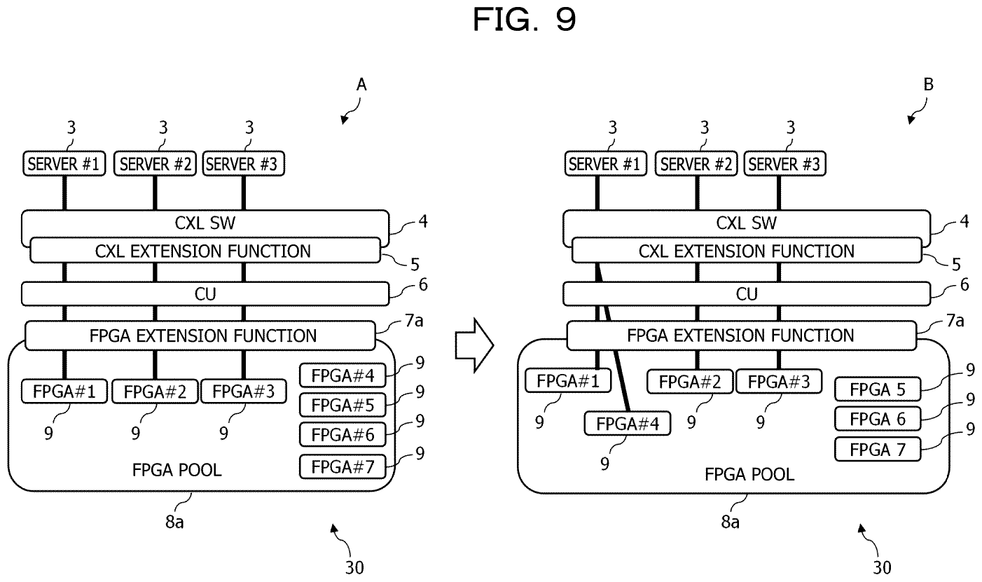

Processing in the local load distribution mode of the computer system 1 as an example of the first embodiment configured as described above will be described according to the sequence diagram illustrated in FIG. 8, with reference to FIG. 9. The processing may be executed by any calculation base unit 30.

FIG. 9 is a diagram illustrating states of the calculation base unit 30 before and after the processing illustrated in the sequence diagram in FIG. 8. In FIG. 9, a reference A indicates a state before execution of the processing illustrated in FIG. 8, and a reference B illustrates a state after the execution of the processing.

Before the processing (before shifting to local load distribution mode), as indicated by the reference A in FIG. 9, the FPGAs #4 to #7, of the plurality of FPGAs #1 to #7 are in the hot standby state. Furthermore, the FPGA #1 is coupled to a server #1, the FPGA #2 is coupled to a server #2, the FPGA #3 is coupled to a server #3 on a one-to-one basis.

Furthermore, hereinafter, an example will be described in which the user terminal inputs the job to the server #1 of the plurality of servers 3 and the FPGA #1 processes this job. Moreover, in a case where the processing delay is detected in the FPGA #1, the monitoring unit 61 determines to append the FPGA #4 as the auxiliary FPGA 9, according to the rule 1 described above. As a result, it is assumed that the processing delay task be parallel processed by the processing delay FPGA #1 and the auxiliary FPGA #4.

In the calculation base unit 30 in the normal mode, when the user terminal inputs the job to the server #1 (refer to reference A1 in FIG. 8), this job is input to the FPGA #1 via the CXL switch 4, the CXL extension functional unit 5, the CU 6, and the FPGA extension functional unit 7a (refer to reference A2 in FIG. 8). The FPGA #1 executes the input job (refer to reference A3 in FIG. 8).

The monitoring unit 61 of the CU 6 monitors the execution of the job by the FPGA #1 and starts analysis (refer to reference A4 in FIG. 8). The monitoring unit 61 measures an execution time of the job by the FPGA #1 (reference A5 in FIG. 8).

When completing the execution of the job, the FPGA #1 transmits an execution result to the server #1 (refer to reference A6 in FIG. 8).

The monitoring unit 61 of the CU 6 monitors the execution time of the job (refer to reference A7 in FIG. 8) and compares the measured execution time with an execution time of the same job at the previous time by the same FPGA #1 (refer to reference A8 in FIG. 8). As a result of this comparison, the execution time of the job is longer than the execution time of the same job at the previous time by a predetermined time or longer, and it is assumed that the monitoring unit 61 detect the processing delay in the FPGA #1. As a result, the calculation base unit 30 shifts from the normal mode to the local load distribution mode.

The server #1 transmits a job execution result to the user terminal, and the user terminal receives the execution result (refer to reference A9 in FIG. 8).

Thereafter, when the user terminal inputs a job to the server #1 again (refer to reference A10 in FIG. 8), the job is transmitted to the CU 6 via the CXL switch 4 and the CXL extension functional unit 5. The monitoring unit 61 of the CU 6 analyzes the input job (refer to reference A11 in FIG. 8). For example, the monitoring unit 61 determines the auxiliary FPGA 9.

In the CU 6, the first special packet processing unit 63 transmits the information used to specify the auxiliary FPGA 9 and the information configuring the auxiliary FPGA 9, together with the special packet issuance request, to the CXL extension functional unit 5 (refer to reference A12 in FIG. 8).

In the CXL extension functional unit 5, the second special packet processing unit 53 receives the special packet issuance request from the CU 6 (refer to reference A13 in FIG. 8), and generates a special packet. The second special packet processing unit 53 transmits the generated special packet to the CU 6 (refer to reference A14 in FIG. 8).

In the CU 6, the first special packet processing unit 63 transfers the special packet to the FPGA extension functional unit 7a. The first FPGA management unit 64a instructs the FPGA extension functional unit 7a to cause the auxiliary FPGA 9 to be in an available state, by transferring the special packet to the FPGA extension functional unit 7a. The instruction to cause the auxiliary FPGA 9 to be in the available state includes each of instructions to perform the coupling, the initialization, and the logical arrangement on the auxiliary FPGA 9 (refer to reference A15 in FIG. 8).

The FPGA extension functional unit 7a receives and reads the special packet (refer to reference A16 in FIG. 8). The FPGA extension functional unit 7a performs the coupling, the initialization, and the logical arrangement on the FPGA #4, according to the instruction to cause the auxiliary FPGA 9 to be in the available state, included in the special packet (refer to reference A17 in FIG. 8). As a result, as indicated by the reference B in FIG. 9, the server #1 can use the FPGAs #1 and #4 by the function of the CXL.

Thereafter, the CU 6 inputs the job to the FPGA extension functional unit 7a (refer to reference A18 in FIG. 8). The FPGA extension functional unit 7a distributedly arranges the jobs in the FPGAs #1 and #4 and causes the FPGAs #1 and #4 to execute parallel processing (refer to references A19 and A20 in FIG. 8).

Execution results of the respective jobs by the FPGAs #1 and #4 are transmitted to the server #1, via the CU 6, the CXL extension functional unit 5, and the CXL switch 4 (refer to references A21 and A22 in FIG. 8).

The monitoring unit 61 of the CU 6 monitors the execution time of the job by each of the FPGAs #1 and #4 (refer to reference A23 in FIG. 8) and compares the measured execution time with each execution time of the same job at the previous time by the same FPGAs #1 and #4 (refer to reference A24 in FIG. 8). Furthermore, the server #1 transmits the job execution result to the user terminal (refer to reference A25 in FIG. 8).

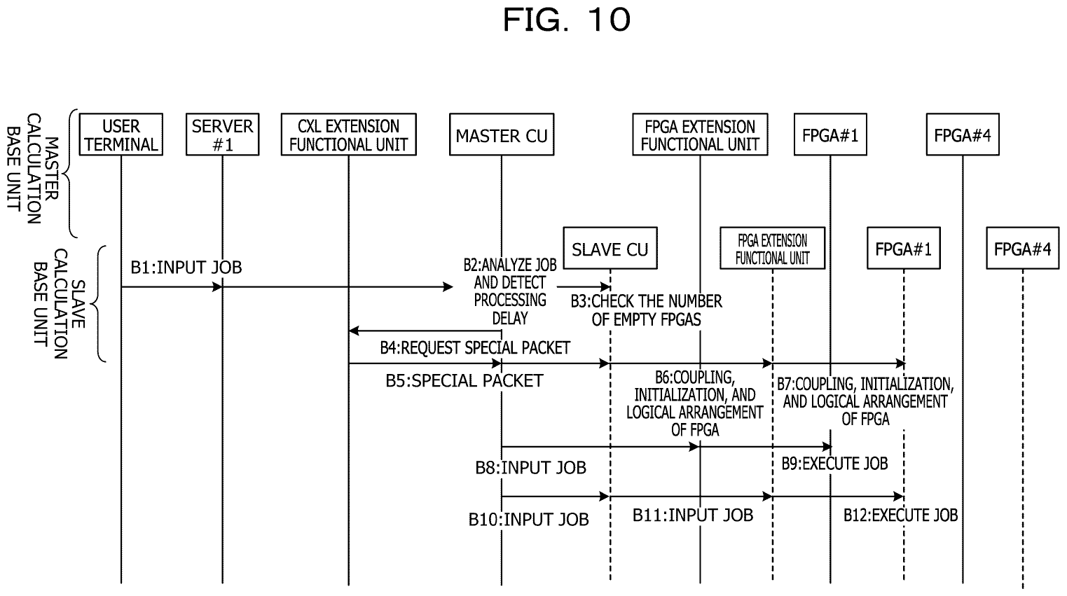

Next, processing in the remote load distribution mode of the computer system 1 as an example of the first embodiment configured as described above will be described according to the sequence diagram illustrated in FIG. 10.

When the user terminal inputs a job to the server #1 of the master calculation base unit 30m (refer to reference B1), this job is transmitted to the master CU 6m via the CXL switch 4 and the CXL extension functional unit 5. The monitoring unit 61 of the master CU 6m analyzes the input job (refer to reference B2). For example, the monitoring unit 61 measures an execution time of the job and compares the execution time with an execution time of the same job at the previous time so as to detect a processing delay (processing delay FPGA 9 and processing delay task). Furthermore, the monitoring unit 61 checks the number of empty FPGAs of the master calculation base unit 30, and in a case where the number of empty FPGAs is zero, the monitoring unit 61 determines to shift to the remote load distribution mode.

The master CU 6m (CU cooperative processing unit 65m) checks the number of empty FPGAs for each slave CU 6s (refer to reference B3) and determines the remote auxiliary FPGA 9.

In the master CU 6m, the CU cooperative processing unit 65m transmits the information used to specify the remote auxiliary FPGA 9 and the information configuring the remote auxiliary FPGA 9, together with the special packet issuance request, to the CXL extension functional unit 5 (refer to B4).

In the CXL extension functional unit 5, the second special packet processing unit 53 receives the special packet issuance request from the master CU 6m and generates a special packet. The second special packet processing unit 53 transmits the generated special packet to the master CU 6m (refer to B5).

In the master CU 6m, the CU cooperative processing unit 65m transfers the special packet to the slave calculation base unit 30s. In the slave calculation base unit 30s, the slave CU 6s transfers the special packet to the FPGA extension functional unit 7a.

The first FPGA management unit 64a instructs the FPGA extension functional unit 7a to cause the remote auxiliary FPGA 9 to be in the available state, by further transferring the special packet to the FPGA extension functional unit 7a. The instruction to cause the remote auxiliary FPGA 9 to be in the available state includes each of the instructions to perform the coupling, the initialization, and the logical arrangement on the remote auxiliary FPGA 9 (refer to B6).

The FPGA extension functional unit 7a receives and reads the special packet. The FPGA extension functional unit 7a performs the coupling, the initialization, and the logical arrangement on the FPGA #1, according to the instruction to cause the remote auxiliary FPGA 9 to be in the available state, included in the special packet (refer to B7). As a result, the server #1 of the master calculation base unit 30m is in a state where the FPGA #1 of the slave calculation base unit 30s can be used by the function of the CXL.

For example, the server #1 of the master calculation base unit 30m can use the FPGA #1 of the master calculation base unit 30m and the FPGA #1 of the slave calculation base unit 30s.

Thereafter, the master CU 6m inputs the job to the FPGA extension functional unit 7a of the master calculation base unit 30m (refer to reference B8). The FPGA extension functional unit 7a arranges the job in the FPGA #1 and causes the FPGA #1 to execute the job (refer to reference B9).

Furthermore, the master CU 6m inputs the job to the slave CU 6s, via the inter-CU optical coupling line 32 (refer to reference B10). The slave CU 6s inputs the job to the FPGA extension functional unit 7a of the slave calculation base unit 30s (refer to reference B11). The FPGA extension functional unit 7a arranges the job in the FPGA #1 of the slave calculation base unit 30s and causes the FPGA #1 to execute the job (refer to reference B12).

As a result, the jobs are distributedly arranged in the FPGA #1 of the master calculation base unit 30m and the FPGA #1 of the slave calculation base unit 30s, and the jobs are parallel processed between the plurality of calculation base units 30.

### [C] Effects

In this way, according to the computer system 1 as an example of the first embodiment, in the CU 6, when the monitoring unit 61 monitors the execution time of the job by each FPGA 9, and detects the processing delay in the FPGA 9, the monitoring unit 61 shifts the mode to the local load distribution mode, and determines the auxiliary FPGA 9.

Furthermore, the first special packet processing unit 63 transmits the special packet issuance request together with the information used to specify the auxiliary FPGA 9 and the information configuring the auxiliary FPGA 9, to the CXL extension functional unit 5.

Then, the CXL extension functional unit 5 generates and issues the special packet, based on the special packet issuance request from the CU 6 (first special packet processing unit 63).

In the FPGA extension functional unit 7a, the third FPGA management unit 72a sets the coupling, the initialization, and the logical arrangement of the auxiliary FPGA 9, based on the specific information used to control the FPGA 9 included in the special packet.

In this way, in a case where the processing delay occurs in the FPGA 9, it is possible to reduce a load of the processing delay FPGA 9 and to improve a job processing performance, by causing the auxiliary FPGA 9 to be in an available state and to execute the job (processing delay task). Furthermore, utilization efficiency of the FPGA 9 in the FPGA pool 8a can be improved.

Furthermore, at this time, the CU 6, the CXL extension functional unit 5, and the FPGA extension functional unit 7a implement the detection of the processing delay in the FPGA 9, the determination of the auxiliary FPGA 9, and the setting of the auxiliary FPGA 9. As a result, since the resources of the server 3 are not used, and in addition, communication with the server 3 is not performed, a load is not applied to the server 3 or the like.

In the CU 6, the first special packet processing unit 63 transmits the special packet issuance request together with the information used to specify the auxiliary FPGA 9 and the information configuring the auxiliary FPGA 9, to the CXL extension functional unit 5. The CXL extension functional unit 5 generates the special packet based on the special packet issuance request from the CU 6 (first special packet processing unit 63) and transmits the special packet to the FPGA extension functional unit 7a. As a result, on the CXL protocol (interconnect standard), the control of the FPGA 9 can be realized between the CU 6, the CXL extension functional unit 5, the FPGA pool 8a, and the FPGA extension functional unit 7a.

For example, in a case where a sudden processing request is issued for any FPGA 9 and an increase in the scale of the system is needed, the monitoring unit 61 in the CU 6 detects the processing delay in the processing delay FPGA 9. The CU 6 can realize addition of the auxiliary FPGA 9 and causes the auxiliary FPGA 9 to process the processing delay task (job), by instructing a scale-up configuration, from among a plurality of configurations prepared in advance, via the special packet, without intervening the server 3.

Furthermore, in the master CU 6m, in a case where the monitoring unit 61 monitors the execution time of the job by each FPGA 9 and detects the processing delay in the FPGA 9, and the usage statuses of the plurality of devices coupled to the first calculation base satisfy the predefined remote load distribution condition, the computer system 1 shifts to the remote load distribution mode.

The CU cooperative processing unit 65m determines the FPGA 9 selected from among the empty FPGAs 9, coupled to the calculation base unit 30, of which the latency is less than the threshold, as the remote auxiliary FPGA 9.

Then, the CU cooperative processing unit 65m transmits the special packet issuance request, together with the information used to specify the remote auxiliary FPGA 9 and the information configuring the remote auxiliary FPGA 9, to the CXL extension functional unit 5.

The CXL extension functional unit 5 generates and issues the special packet, based on the special packet issuance request from the master CU 6m (CU cooperative processing unit 65m). The master CU 6m transfers the special packet to the slave calculation base unit 30s, and the remote auxiliary FPGA 9 is in an available state in the slave calculation base unit 30s.

As a result, the server #1 of the master calculation base unit 30m can use the FPGA #1 of the master calculation base unit 30m and the FPGA #1 of the slave calculation base unit 30s.

In this way, in a case where the processing delay occurs in the FPGA 9 of the master calculation base unit 30m, by causing the remote auxiliary FPGA 9 to be in the available state and to execute the job (processing delay task), it is possible to reduce the load of the processing delay FPGA 9 and improve the job processing performance.

Furthermore, by using the FPGA 9 that is not used in the slave calculation base unit 30s as the remote auxiliary FPGA 9 and causing the FPGA 9 to execute the processing delay task, it is possible to improve an operation rate and utilization efficiency of the calculation resource (FPGA 9) in the computer system 1. For example, by adapting this method to a large-scale data center having the plurality of calculation base units 30, it is possible to attempt to optimize the entire data center.

Typically, in the computer system 1 configured by coupling the plurality of calculation base units 30, a virtualization technology is mainly used as a technology for improving an operation efficiency of equipment. However, it is possible to improve the operation efficiency of the computer system 1, without using such a virtualization technology.

Furthermore, at this time, the master CU 6m, the slave CU 6s, each of the CXL extension functional units 5 of the master calculation base unit 30m and the slave calculation base unit 30s, and each of the FPGA extension functional units 7a of the master calculation base unit 30m and the slave calculation base unit 30s implement the detection of the processing delay in the FPGA 9, the determination of the remote auxiliary FPGA 9, and the setting of the remote auxiliary FPGA 9. As a result, the resource of the server 3 is not used in any of the master calculation base unit 30m and the slave calculation base unit 30s, and the communication with the server 3 is not performed. Therefore, no load is applied to the server 3 or the like.

### Second Embodiment

In the computer system 1 according to the first embodiment described above, in a case where the mode shifts to the remote load distribution mode, the master calculation base unit 30m determines the remote auxiliary FPGA 9 from among all the slave calculation base units 30s.

However, a case is considered where a business operator or the like does not desire to use an FPGA 9 of a specific calculation base unit 30 as the remote auxiliary FPGA 9, due to some circumstances (convenience). Furthermore, on the other hand, a case is also considered where it is desired to preferentially use the FPGA 9 of the specific calculation base unit 30 as the remote auxiliary FPGA 9.

In a computer system 1 according to the second embodiment, it is possible to reflect convenience of the business operator or the like, on the determination of the remote auxiliary FPGA 9.

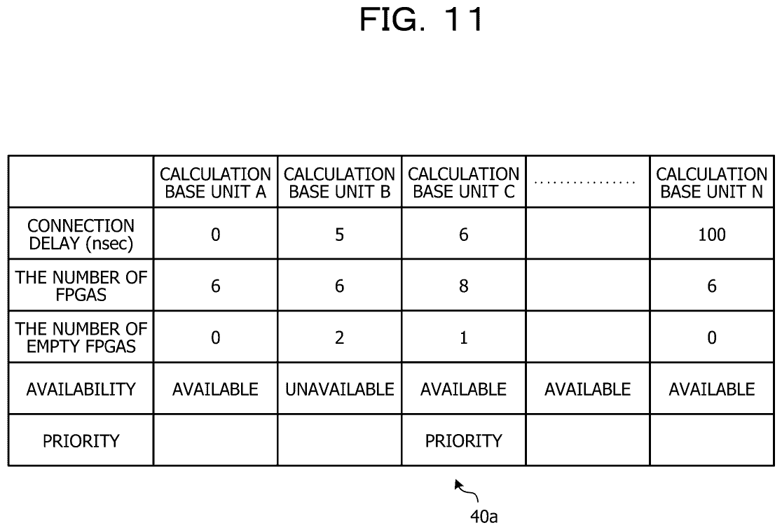

FIG. 11 is a diagram illustrating calculation base management information 40a of the computer system 1 according to the second embodiment.

This calculation base management information 40a includes availability and priority as management items, in addition to the calculation base management information 40 according to a first data processing unit 104 embodiment illustrated in FIG. 6.

The availability is information indicating whether or not to permit to use the FPGA 9 as the remote auxiliary FPGA 9, and for example, in a case of permitted, “available” is set, and in a case of not permitted, “unavailable” is set. In a case where the business operator or the like desires that the FPGA 9 of the specific calculation base unit 30 is not used from another calculation base unit 30, the business operator or the like sets “unavailable” to the specific calculation base unit 30.

The priority is information indicating whether or not to preferentially use the FPGA 9 as the remote auxiliary FPGA 9. For example, in a case where the business operator or the like desires that the FPGA 9 of the specific calculation base unit 30 is used as the remote auxiliary FPGA 9, the business operator or the like sets “priority” to the calculation base unit 30.

Such a business operator convenience (convenience of operation by operator) may be input to a master CU 6m via an inter-CU management coupling line 33.

The master CU 6m (CU cooperative processing unit 65m) prevents the FPGA 9 of the calculation base unit 30 for which “unavailable” is set to the availability from being used as the remote auxiliary FPGA 9, in such calculation base management information 40a.

Furthermore, the master CU 6m (CU cooperative processing unit 65m) preferentially uses the FPGA 9 of the calculation base unit 30 for which “priority” is set to the priority, as the remote auxiliary FPGA 9, in the calculation base management information 40a.

The calculation base management information 40a is an example of selection restriction information. Furthermore, the availability and the priority of the calculation base management information 40a are conditions set based on the convenience of the business operator and are examples of conditions that the preset selection restriction information indicates.

It is assumed that the availability and the priority of the calculation base management information 40a be not automatically updated until the business operator updates.

In the computer system 1 according to the second embodiment, components other than the calculation base management information 40 are similar to those of the first embodiment, and description thereof is omitted.

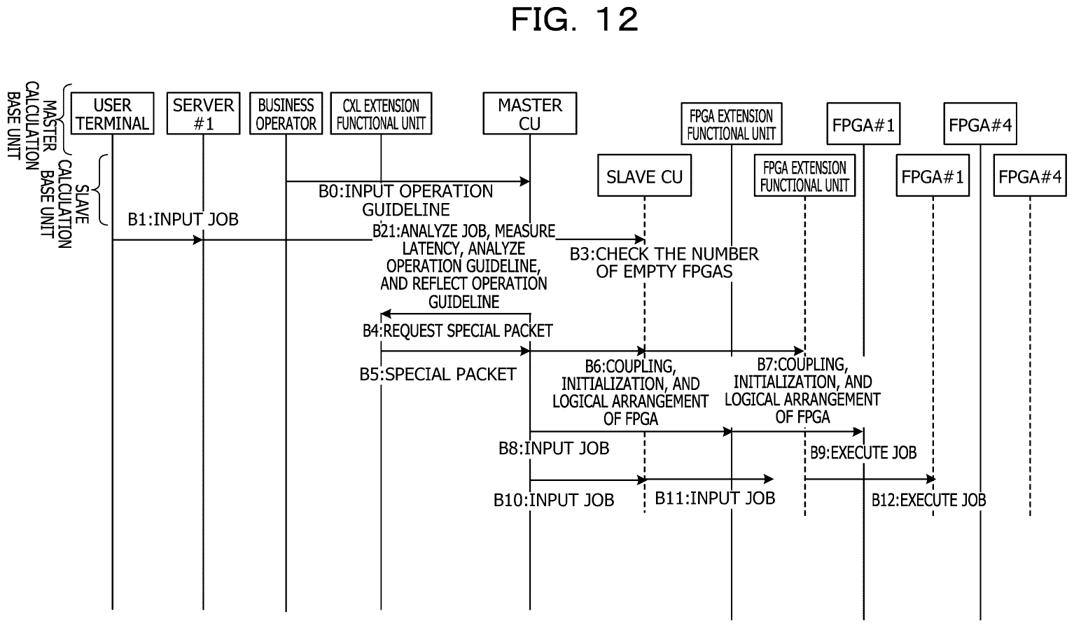

Processing in the remote load distribution mode of the computer system 1 as an example of the second embodiment configured as described above will be described according to the sequence diagram illustrated in FIG. 12.

In the sequence diagram illustrated in FIG. 12, processing indicated by a reference B0 is added to the sequence diagram illustrated in FIG. 10, and processing indicated by a reference 21 is executed instead of the processing with the reference B2. Since processing with the same reference as the reference described above, other than these, is the same as that in the sequence diagram illustrated in FIG. 10, description thereof is omitted.

The business operator inputs the availability and the priority of the calculation base management information 40a as an operation guideline (refer to reference B0).

In the master calculation base unit 30m, when a job is input from a user terminal (refer to reference B1), the master CU 6m analyzes the input job (refer to reference B21). For example, the monitoring unit 61 measures an execution time of the job and compares the execution time with an execution time of the same job at the previous time so as to detect a processing delay (processing delay FPGA 9 and processing delay task). Furthermore, the monitoring unit 61 checks the number of empty FPGAs of the master calculation base unit 30, and in a case where the number of empty FPGAs is zero, the monitoring unit 61 determines to shift to the remote load distribution mode.

The master CU 6m (CU cooperative processing unit 65m) checks the number of empty FPGAs for each slave CU 6s (refer to reference B3) and determines the remote auxiliary FPGA 9. At this time, the CU cooperative processing unit 65m analyzes the calculation base management information 40a, and reflects the availability and the priority of the calculation base management information 40a on the determination of the remote auxiliary FPGA 9.

For example, the CU cooperative processing unit 65m does not use the FPGA 9 of the calculation base unit 30 for which “unavailable” is set to the availability in the calculation base management information 40a, as the remote auxiliary FPGA 9.

Furthermore, the CU cooperative processing unit 65m preferentially uses the FPGA 9 of the calculation base unit 30 for which “priority” is set to the priority in the calculation base management information 40a, as the remote auxiliary FPGA 9.

For example, a data center business operator has a demand for controlling an operation rate of calculation resources due to the convenience of the business operator. For example, maintenance, cooperation with air conditioning equipment, equipment rent (housing), or the like is exemplified as the reasons why it is desired to control the operation rate. For example, it is desired to operate a calculation base unit 30 installed in a place where maintainability is poor or air conditioning is poor, with a low load. Since controlling the operation rate can be reflected on cost of a service to be provided, there is a gain not only for the business operator but also for a system user side.

According to the computer system 1 according to the second embodiment, workings and effects similar to those of the first embodiment can be obtained, and by arbitrarily setting the availability and the priority of the calculation base management information 40a by the business operator according to the operation guideline, it is possible to control the operation rate of the calculation resources of the computer system 1 according to the convenience of the business operator, and this results high convenience.

### OTHERS

Then, the disclosed technology is not limited to each of the embodiments described above, and various modifications may be made and implemented in a range without departing from the gist of each of the embodiments.

The computer system 1 according to each embodiment described above includes the FPGA pool 8a, and the CU 6 implements the function for controlling the FPGA 9 of the FPGA pool 8a. However, the embodiment is not limited to this. For example, the embodiment may be applied to the control of the GPU 13 of the GPU pool 8b, the storage device of the storage pool 10, the memory device of the memory pool 11, or the like, and various modifications can be made.

Furthermore, in each embodiment described above, an example has been described where the CU 6 is included independently from the CXL switch 4. However, the embodiment is not limited to this. For example, the CXL switch 4 and the CU 6 may be integrally formed. Furthermore, the CU 6 may include the functions as the FPGA extension functional unit 7a and the GPU extension functional unit 7b.

Furthermore, each configuration and each processing of each embodiment may be selected or omitted as needed or may also be appropriately combined.

Furthermore, those skilled in the art may carry out or manufacture each embodiment according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device included in a first calculation base of a plurality of calculation bases, in a computer system that includes the plurality of calculation bases each that includes a first processor, an interconnect switch that conforms to an interconnect standard, and a plurality of devices coupled to the first processor via the interconnect switch, the information processing device comprising:
a memory; and
a second processor coupled to the memory and configured to:
in a case of detecting a processing delay with respect to a processing target in a first device of the plurality of devices included in the first calculation base and where each usage status of the plurality of devices included in the first calculation base satisfies a predefined remote load distribution condition,
cause a second device of unused devices of the plurality of devices, the second device being included in a second calculation base of the plurality of calculation bases, a connection delay of the second calculation base being less than a predetermined value, to process the processing target, based on each usage status of the plurality of devices included in each of the plurality of calculation bases and each connection delay of a communication path from the first calculation base to each of the plurality of calculation bases.

2. The information processing device according to claim 1,
wherein the first calculation base is configured to:
generate a device control packet used to control the second device, based on a packet that conforms to the interconnect standard, and
control the plurality of devices,
wherein the second processor requests the first calculation base to issue the device control packet, and
wherein the first calculation base sets the second device to be in an operable state, based on the device control packet generated by the first calculation base.

3. The information processing device according to claim 2,
wherein a device of the plurality of devices is a field programmable gate array (FPGA), and
wherein the first calculation base sets logical arrangement of the FPGA according to the device control packet.

4. The information processing device according to claim 1,
wherein the second device is included in a third calculation base of the plurality of calculation bases, the third calculation base satisfying a condition that preset selection restriction information indicates, among the calculation bases of which the connection delay is less than the predetermined value.

5. A non-transitory computer-readable recording medium storing a program that causes a computer included in an information processing device included in a first calculation base of a plurality of calculation bases, in a computer system that includes the plurality of calculation bases each that includes a processor, an interconnect switch that conforms to an interconnect standard, and a plurality of devices coupled to the processor via the interconnect switch, the computer executing a process, the process comprising:
in a case of detecting a processing delay with respect to a processing target in a first device of the plurality of devices included in the first calculation base and where each usage status of the plurality of devices included in the first calculation base satisfies a predefined remote load distribution condition,
causing a second device of unused devices of the plurality of devices, the second device being included in a second calculation base of the plurality of calculation bases, a connection delay of the second calculation base being less than a predetermined value, to process the processing target, based on each usage status of the plurality of devices included in each of the plurality of calculation bases and each connection delay of a communication path from the first calculation base to each of the plurality of calculation bases.

6. The non-transitory computer-readable recording medium according to claim 5, wherein the first calculation base is configured to:
generate a device control packet used to control the second device, based on a packet that conforms to the interconnect standard, and
control the plurality of devices,
wherein the process requests the first calculation base to issue the device control packet, and
wherein the first calculation base sets the second device to be in an operable state, based on the device control packet generated by the first calculation base.

7. The non-transitory computer-readable recording medium according to claim 6,
wherein a device of the plurality of devices is a field programmable gate array (FPGA), and
wherein the first calculation base sets logical arrangement of the FPGA according to the device control packet.

8. The non-transitory computer-readable recording medium according to claim 5,
wherein the second device is included in a third calculation base of the plurality of calculation bases, the third calculation base satisfying a condition that preset selection restriction information indicates, among the calculation bases of which the connection delay is less than the predetermined value.

9. A control method of an information processing device included in a first calculation base of a plurality of calculation bases, in a computer system that includes the plurality of calculation bases each that includes a first processor, an interconnect switch that conforms to an interconnect standard, and a plurality of devices coupled to the first processor via the interconnect switch, the control method comprising:
in a case of detecting a processing delay with respect to a processing target in a first device of the plurality of devices included in the first calculation base and where each usage status of the plurality of devices included in the first calculation base satisfies a predefined remote load distribution condition,
cause a second device of unused devices of the plurality of devices, the second device being included in a second calculation base of the plurality of calculation bases, a connection delay of the second calculation base being less than a predetermined value, to process the processing target, based on each usage status of the plurality of devices included in each of the plurality of calculation bases and each connection delay of a communication path from the first calculation base to each of the plurality of calculation bases, by a second processor.

10. The control method according to claim 9,
wherein the first calculation base is configured to:
generate a device control packet used to control the second device, based on a packet that conforms to the interconnect standard, and
control the plurality of devices,
wherein the second processor requests the first calculation base to issue the device control packet, and
wherein the first calculation base sets the second device to be in an operable state, based on the device control packet generated by the first calculation base.

11. The control method according to claim 10,
wherein a device of the plurality of devices is a field programmable gate array (FPGA), and
wherein the first calculation base sets logical arrangement of the FPGA according to the device control packet.

12. The control method according to claim 9,
wherein the second device is included in a third calculation base of the plurality of calculation bases, the third calculation base satisfying a condition that preset selection restriction information indicates, among the calculation bases of which the connection delay is less than the predetermined value.
